(19) United States
(12) Patent Application Publication
(10) Pub. No.: US 2009/0119377 A1
(43) Pub. Date: May 7, 2009

(54) MANAGING COMMUNICATIONS ON AN R-SMART NETWORK

(75) Inventor: Thomas W. Lynch, Galveston, TX (US)

Correspondence Address: AMIN, TUROCY & CALVIN, LLP, 127 Public Square, 57th Floor, Key Tower, CLEVELAND, OH, 44114, US

(73) Assignee: LIANG HOLDINGS LLC, Wilmington, DE (US)

(21) Appl. No.: 11/936,693

(22) Filed: Nov. 7, 2007

(51) Int. Cl. G06F 15/16

(52) U.S. Cl. 709/206

(57) ABSTRACT

Implementations related to managing communications on r-smart networks are disclosed.

### BACKGROUND

Communication is an increasingly important component of most people's lives and the average person may make contact with hundreds of other people. There is an increasing trend in the number of contacts, and this has created new challenges for managing contacts.

Some social scientists maintain that most communication is emotional and that analytical content is secondary, if present at all. Whether justified or not, caring and emotions are frequently termed “right brain” activities, and hence being good at these activities is sometimes referred to as “r-smartness” which is short for “right brain smartness”.

People often use r-smartness in determining how they communicate with other people. In some cultures this may be very pronounced, and may even affect the vocabulary and grammar of a conversation. For example, in pre-modern Europe, third person and indirect terms were used when conversing with royalty. As another example, in Japan different forms of address are used depending on whether one is speaking to children, family, co-workers, elders and bosses. Take for instance the Japanese word for thank you. It may take the form of “domo”, “domo arigato”, and “domo arigato gozaimasu” depending on the perceived acting role and status difference in the conversation. Thus, in this context, acting roles may include such things as parent-child, student-teacher, employee-boss, among others. Furthermore, status differences may be based on age, attainment in a skill, spiritual attainment, money, among others. Indeed, this also exists in a less formal form in American English with “thanks”, “thank you”, and “thank you very much⇄ and other variations said in different tones and intonations. However, r-smartness comes into play in a variety of situations, not just when saying thank you.

As telecommunication means have diversified from simple land-line phones to include, among others, PDAs (personal digital assistants), cell phones, email devices such as desktop computers and laptops, and the like, the use of simple phone books and operator assistance may no longer be optimum means for keeping track of contacts. As a result, personally owned contacts lists are playing a larger role in people's lives. Enhancing such personally owned contacts lists may result in smother communications and enhanced productivity.

In addition, the nature of relationships between people and the roles they play in each other lives affects how they communicate with each other. Consider, for example, the relationship between an executive and a salesman. The executive may be interested in hearing what the salesman has to say between meetings, but he likely will not be interested in doing so during a staff meeting. In contrast, consider the relationship between this executive and the company president. If the company president should call with an important message during the staff meeting, then the executive may very well want to receive that call. In short, relationship definitions and roles may have profound affects on the perception of the appropriateness of communications in various scenarios.

Clearly, certain types of communications may be more appropriate during certain times and/or circumstances. For example, it may not be appropriate for a cell phone to ring, or for a laptop computer to issue a “you've got mail” notice while in a meeting with one's boss. Thus, for example, it may be more convenient for calls from friends to go to voice mail during work hours, and for emails from friends not to give notice during work hours. Whereas, at night and while on vacations, an individual may not wish to be interrupted by communications from the office.

### BRIEF DESCRIPTION OF THE DRAWINGS

Subject matter is particularly pointed out and distinctly claimed in the concluding portion of the specification. Claimed subject matter, however, both as to organization and method of operation, together with objects and features thereof, may best be understood by reference of the following detailed description if read with the accompanying drawings in which:

FIGS. 1 and 2 illustrate example scenario lists;

FIG. 3 illustrates an example implication rule;

FIG. 4 illustrates an example system; and

FIG. 5 illustrates an example method.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the following detailed description are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical, magnetic and/or electromagnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

In the context of this disclosure, and the claims that follow, the term “ring” may be used to describe the grouping of personal contacts and the phrase “ring properties” may be used to describe properties associated with a group of contacts. Similar meanings of the term “ring” may be found, for example, in the area of abstract algebra, and in colloquial terms such as “crime ring”. Claimed subject matter is not limited in this regard however, and, thus, a grouping of contacts in accordance with claimed subject matter may be described as a “ring”, a “group”, a “domain”, to name just a few examples. Thus, within this disclosure, use of the term “ring” should not be understood as describing a literal geometric shape, even though such shapes may be employed in network diagrams, etc., that may be used to illustrate example implementations of claimed subject matter.

For many individuals the day may be partitioned into time intervals and/or event categories having related purposes. For example, early hours may be for preparing for the day, morning and afternoon hours may be spent at the office, the noon hour may be for lunch, the early evening may comprise personal time, the dinner hour and late evening hours may be dedicated to family, and the weekends may be devoted to recreation, etc. For purposes of this disclosure, time intervals and/or event categories and/or types of situations may be referred to simply as “scenarios” or “events”. Further, in accordance with claimed subject matter, scenarios may be associated with scenario “properties”. For instance, in the above example, scenario properties may include, “preparation” associated with a morning scenario, “lunch” associated with a noon hour scenario, etc.

Further, while scenarios may be associated with a specific time interval or period, claimed subject matter is not limited in this regard. Thus, scenarios in accordance with claimed subject matter may be defined with respect to any contextual elements that may be associated with a set of behavioral expectations that, in turn, may, or may not, be associated with specific temporal circumstances. In addition, in the context of this disclosure and/or claimed subject matter, contextual elements of a scenario may set behavioral expectations associated with that scenario and may include, but are not limited to, time of day and/or year, social setting (e.g., work, family, friends, etc.), etc. Hence, for example, a “business meeting” event could occur at any time, although for many individuals there might be an expectation that such a scenario would occur between 8 AM and 5 PM on weekdays. For another example, an “in transit” or “traveling” property may be associated with a “vacation” scenario or event where the property of being “in transit” may be somewhat randomly temporally associated with the “vacation” scenario that, in turn, may represent a “one off” or asynchronous event.

Yet, further, in accordance with claimed subject matter, scenario or event names themselves may comprise properties. For example, a morning scenario may be associated with a name property comprising “morning”, a noon hour scenario may be associated with a name property comprising “noon hour”, etc. In some embodiments of claimed subject matter, scenarios may be described by a list format.

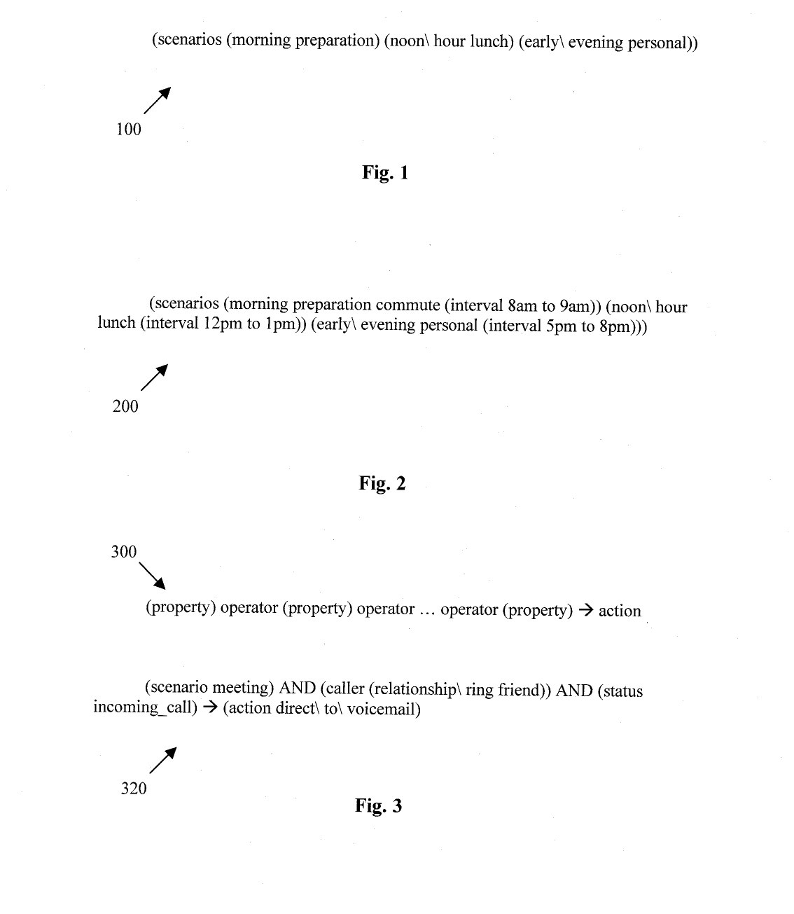

FIG. 1 illustrates an example scenario properties list 100 in accordance with some implementations of claimed subject matter. As shown in the implementation of FIG. 1 a scenario name may be the first property listed. Those skilled in the arts of programming and databases may recognize many other possible schemes for listing scenario information. Hence, list 100 should be considered pedagogical and not limiting with respect to the conveyance of scenario properties. In accordance with claimed subject matter, other properties associated with a named scenario may follow a scenario name. In the example of list 100 each scenario has been associated with one property. Claimed subject matter is not limited in this regard, however, and, hence, any number of properties may occur within a list and/or may be associated with one or more scenarios.

Those skilled in the art may recognize that textual representations of lists having embedded spaces, such as in scenario names of FIG. 1, may be problematic. One commonly used solution to the embedded space problem comprises using a back slash as a special escape character. In such schemes a back slash followed by a space may be considered to comprise a space embedded in the identifier, rather than as a delimiter between identifiers. While list 100 as shown employs a back slash as a special escape character, many other techniques, well known to those familiar with the art, may be employed for dealing with embedded spaces, and the use of this technique in list 100 should not be construed to limit claimed subject matter in any way.

Furthermore, in accordance with some implementations of claimed subject matter, properties themselves may be associated with sub-properties. In such implementations, when represented using a list method, a property and its associated sub-properties may appear as a sub-list. FIG. 2 illustrates, in accordance with some implementations of claimed subject matter, an example scenario list 200 that employs both multiple properties and associated sub-properties.

In the example implementation of FIG. 2, a scenario named “morning” is associated with three properties, “preparation”, “commute”, and “interval”. In turn, the morning interval property is associated with two sub-properties, namely “8 am” and “9 am”. Scenarios are not, however, limited to being associated with names. Thus, in some implementations of claimed subject matter, properties themselves may convey useful information. Moreover, in implementations of claimed subject matter employing list representations, the lack of a name may be represented by, for example, the 'nil symbol.

Implementations employing list representations, such as shown in the example implementations of FIGS. 1 and 2, are not intended to be limiting in any way, and, thus, many other schemes exist for the expression of scenario properties and analogous items in accordance with claimed subject matter. For example, in other implementations, a graphical calendar may be employed. In such implementations, properties may be implied with respect to appointments on a calendar. Some of these appointments may be recurring. Further, in some implementations in accordance with claimed subject matter, electronic schedule calendars may be modified to allow a user to explicitly express scenario names, their times of occurrence, and/or associated properties. For example, consider the noon hour scenario of list 200. A user with a calendar application that has been modified to support scenarios in accordance with claimed subject matter may create a recurring scenario between 12 and 1 every weekday. Such a scenario may differ from an appointment because it describes a customary scenario that occurs during a particular time interval and does not necessarily imply a meeting or any other specific event. In accordance with some implementations of claimed subject matter a scheduled scenario of a modified calendar program may be edited to add additional scenario properties.

To further illustrate, another example general scenario or event may be a “business meeting”. Similar to other scenarios described herein, individuals may have certain expectations or behavioral norms associated with events such as business meetings. For example, a user may expect that a phone does not ring, but rather vibrates during a business meeting. Further, a user may expect that if a call is from the user's “boss” then the phone should ring during a business meeting scenario whereas, if a call is from an “important” contact and/or someone the user holds in high esteem, then the phone should vibrate only, or, if the call is from anyone else then the phone should remain silent. In accordance with some implementations of claimed subject matter, algorithms executing on a phone or other communications device may be supplied, modified, etc. such that, for communications originating from certain contacts, the device may divert a call over to voice mail rather than vibrate when a distant relative calls during a business meeting for example, or undertake various other actions in different scenarios or events depending upon who is attempting to contact the user and/or how the user has categorized the contact.

In accordance with some implementations of claimed subject matter, user contacts may also be associated with properties. Various implementations exist for binding properties to contacts and capturing property information in accordance with claimed subject matter. One such implementation comprises a list representation, such as introduced above in FIGS. 1 and 2 for scenario properties. In some implementations employing list representations of contact properties, a head of a list may comprise a reference to a contact. There are many ways to reference a contact, such as by address pointer, record id, index, and primary label, contextual implication, among others. Subsequent to a contact reference, a list representation of contact properties may include a list of properties associated with the contact. As for list representations of scenario properties, properties in a list representation of contact properties may be associated, in a nested manner, with sub-properties.

In accordance with some implementations of claimed subject matter, a property that may be associated with one or more contacts may be the role those contacts play in the users life. For example, role properties may include “father”, “mother”, “wife”, “boss”, “accountant”, “school principal”, etc.

Similar to the manner in which scenarios and contacts may be associated with properties, in accordance with some implementations of claimed subject matter, relationship rings, as set forth in co-pending application R-SMART PERSON-CENTRIC NETWORKING, may also be associated with properties. In this disclosure and the claims that follow a relationship ring, or simply a “ring”, may comprise a group of personal contacts where that group shares a common property such as a degree of familiarity and/or affection, a respect, status, and/or esteem level, and/or an acting role. In other words, such properties may reflect how a user feels about a personal contact.

In some implementations of claimed subject matter employing list representations, a list head may comprise a reference to a ring, while the list itself provides properties associated with that particular ring. As in the case of scenarios and contacts, many implementations for properties associated with a relationship ring may be apparent to those skilled in the art. For example, in some implementations, a property of a ring may comprise a list of references to contacts belonging to the ring. For another example, a relationship ring may be associated with a “notification level” property comprising an integer sub-property. If, for example, a notification level property is set low for a particular ring, then a notification (e.g., ringing sound) regarding communications (e.g., calls, emails, etc.) received from that ring may be provided to a user at a lower volume, depending on the user's particular scenario.

In accordance with claimed subject matter, properties associated with scenarios, contacts and/or relationship rings are not limited to a particular format. Thus, in some implementations, properties may, for example, comprise data in an American Standard Code for Information Interchange (ASCII) format, while in other implementations, properties may, for example, comprise data in a binary format. Moreover, in accordance with claimed subject matter, property lists may have many analogous structures, including data structures, Extensible Markup Language (XML), indexed arrays, among many others. Moreover, claimed subject matter is not limited to the term “property”, and thus, in some implementations, different nomenclature may be used so that properties may be called attributes, indexes, references, additional information, or be referred to by a myriad of different terms.

In accordance with claimed subject matter some properties may be assigned to different agents. For example, ring membership may be associated with a relationship ring as a property of that ring. In some implementations, ring membership may be explicitly listed as a property of a ring, while in other implementations ring membership may be implied. For example, ring membership property may be implied when ring relationships are listed for contacts. Similarly, many other properties will also take implied or explicit forms, or may be attached to various agents. Further, in some implementations in accordance with claimed subject matter, properties belonging to a ring may be inherited by sub-rings and/or by contacts belonging to a ring or sub-rings.

In some implementations of claimed subject matter, communication related status may include properties related to a state or state(s) of a terminal unit or communication device. For example, in some implementations, a communication related status for a cell phone may comprise “busy”. In this context, the property busy may exist when someone is talking on the phone. In other implementations, a more sophisticated form of such a property may convey a number of people engaged in communication on a terminal unit, for example, “engaged_number”. Thus, in some implementations, a property may be properties. For instance, using the example of an engaged_number property, a particular value for this property might be “engaged 3” signifying that a user may be on a conference call with two other individuals at a particular moment. In general, communication related status properties may be implied by terminal device hardware, a context that a control program executing on a terminal device is in, or listed explicitly somewhere in a communications system or even in a computer registry, among a myriad of other possibilities.

In some implementations of claimed subject matter, a communication action may comprise an action that a terminal device undertakes when handling communication. Again, such a communication action may comprise a property associated with a terminal device and/or a communications system. For example, if a laptop computer emits a sound (e.g., chimes) when new mail arrives, the act of emitting a sound may comprise a communication action. Thus, for one example, a terminal device (e.g., laptop), may employ a communication action “do_sound(N)” where the function “do_sound” includes an argument “N” determining the volume at which the terminal device emits a sound. As another example, when a call reaches a cell phone, the phone may ring with a special ring tone, or vibrate. Such functions may, in some implementations of claimed subject matter, comprise communications action properties such as, for example, “do_ring(ring_tone)”, or “vibrates”, etc. For example, a communications action comprising a do_ring function may accept an integer argument that specifies which ring tone to use.

Other communication actions may control initiating communication, handling interrupts, and a host of other things. These are just a few examples and because actual interfaces used on devices vary widely across manufacturers, across models, and even across software releases and applications employed, among other variables, claimed subject matter is not limited to the few examples presented herein. Moreover, a communication action may not appear explicitly in source code, for example, but may be implied, mixed in with other actions, placed in hardware, be a mixture of these, or have other variations, claimed subject matter not being limited in this regard either.

In some implementations of claimed subject matter, implication rules may employ operators to act on properties in order to invoke communication related actions. Operators may comprise any function that operates on properties that a particular device may implement either directly or indirectly. For example, a common operator may comprise a conjunction. FIG. 3 illustrates a general implication rule 300 and an example implication rule 320 employing conjunction operators.

In FIG. 3, example implication rule 320 directs incoming calls received from those contacts belonging to a friend relationship ring to voicemail when those calls are received during a meeting scenario. In this example, implication rule 320 conjoins three properties 322-326: property 322 associated with a current scenario, property 324 derived from comparing a caller id with relationship ring information, and property 326 identifying that the communication event comprises an incoming call. Thus, in example rule 320: property 322 specifies a meeting where this property may have been derived from a calendar combined with a current time, and property 324 may be derived from comparing a caller id with relationship ring information where the relationship ring information identifies that the caller is calling in the role of a friend. In some implementations of claimed subject matter, a caller may choose to call in any one of a number of different roles.

The third property of rule 320, property 326, identifies that the communication event comprises an incoming call. It should be understood that in some implementations, for example when a terminal device comprises a multimedia device, a communications event could comprise an incoming call, a text message, or an email, among other possibilities. The arrow in rules 300 and 320 signifies the implication operator whereas the items on the left side of the implication operator (e.g., properties 322-326 in rule 320) are used to trigger the implication. Thus, in the context of rule 320, the right side of an implication rule indicates what to do when the left side is satisfied. Hence, rule 320 provides that a conjunction of being in a meeting and having a friend call triggers action 328 thereby sending the call directly to voice mail.

In some implementations of claimed subject matter, implication rules, such as rule 320, may be created in advance, and made active by a user. In various implementations, such rules may be active all of the time, or turned on and off, depending, for example, on a given scenario and/or on user preferences. Further, some implementations may support a variety of operators. For example, some implementations may effect some or all of, among others: +−*></== AND OR XOR ON OFF DURING PROCEEDING AFTER, etc. Claimed subject matter is not limited to specific operators and the preceding list is not intended to be an exhaustive listing of all possible operators.

While examples of communications actions have been provided above, there are many possible communication actions in accordance with implementations of claimed subject matter. For further example, another type of communication action in accordance with some implementations of claimed subject matter may comprise an automatic response. Further, when employing implication rules in accordance with some implementations of claimed subject matter responses may be provided based on rings, roles, and/or scenarios. For example, in some implementations, unknown callers may be told to send email to an administrative address.

Further, in accordance with some implementations of claimed subject matter, scenarios or events may be employed to classify appointments on a calendar. For example, meetings with contacts from particular relationship rings may imply that a scheduled meeting comprises a business meeting. Such expectations may be captured in, for example, calendar appointment implication rules. In this context, an implication rule may generate a property that may in turn be used in other rules. Thus, in accordance with some implementations of claimed subject matter, once calendar implication rules have been generated, appointments placed on a calendar may automatically invoke certain rules and/or create scenario properties.

In some communications systems, in accordance with some implementations of claimed subject matter, one or more implication rules may be provided by default by manufacturers and/or designers of such systems. In some implementations, some and/or all of these rules may and/or may not be modifiable by the user. In various implementations, implication rules may be modified by an application programmer, a user, a system administrator, or any combination of these or other means.

In accordance with some implementations of claimed subject matter, additional implication rules may be chosen by a user from a menu system. In other implementations, a user may invoke a rule management application permitting the user to add new rules, delete old rules, and perform various rule maintenance functions. Such a rule management application may include a rule editor permitting a user to create implication rules by concatenating selected properties, operations, and implied actions from selections on various menus. In accordance with some implementations of claimed subject matter, a user may be allowed to directly enter and/or formulate rules using a grammar or format, such as shown in the examples in this application or via a different grammar or format. Further, in accordance with some implementations of claimed subject matter, implication rules may take the form of programs or algorithms accepting as input various properties to be affected, and calling actions as other routines in the system. Further, in some implementations, implication rules may be programmed in field programmable devices, or embedded directly in hardware.

### Example System

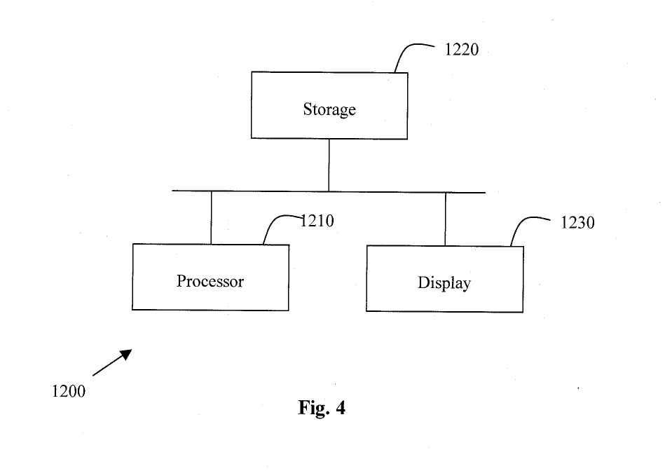

FIG. 4 is a block diagram of an example communications system 1200. System 1200 may be used to perform some or all of the various functions discussed above in connection with FIGS. 1-3. System 1200 may comprise any device or collection of devices capable of facilitating communication of information. For example, system 1200 may comprise a terminal device such as desktop computer, a laptop computer, a handheld computer, a smart and/or cellular telephone, a PDA, etc.

System 1200 includes a central processing unit (CPU) 1210 such as a processor capable of providing and/or facilitating communications functions, memory 1220 coupled to CPU 1210, and a display device 1230 coupled to CPU 1210 and/or memory 1220. It will be recognized by those skilled in the art that a graphics processing unit (GPU), not shown in FIG. 12, may be coupled to CPU 1210 and/or may be internal to CPU 1210, and may be coupled to display device 1230 in order to provide display device 1230 with displayable information. Such displayable information may be presented on display device 1230 in the form of a GUI where that GUI may be capable of providing visual representations of r-smart person-centric networks and/or messages in accordance with some implementations of claimed subject matter.

In accordance with some implementations of claimed subject matter, CPU 1210 may include logic facilitate, build, generate and/or operate on internal representations such as list structures, data structures and/or arrays used to define r-smart person-centric networks. Further, in accordance with some implementations of claimed subject matter, memory 1220 may act in conjunction with CPU 1210 to store or hold at least portions of such internal representations.

Those skilled in the art will recognize that memory 1220 and/or CPU 1210 may be further coupled to a memory controller, not shown in FIG. 12, that may facilitate the communication of information, such as information specifying a GUI, between CPU 1210 and/or memory 1220. Further, memory 1220, which may comprise memory internal to CPU 1210, and/or which may comprise one or more discrete memory devices external to CPU 1210, may comprise any memory technology (e.g., random access memory (RAM), flash memory, etc.). In accordance with some implementations of claimed subject matter, memory 1220 may, at least temporarily, store or hold information capable of providing visual representations of r-smart person-centric networks and/or messages. Such information may comprise, for example, information specifying at least portions of a GUI capable of providing visual representations of r-smart person-centric networks and/or messages and capable of being displayed on display device 1230.

Display device 1230, which may comprise any type of display device such as a Liquid Crystal Display (LCD) display, a polymer-based display, an electroluminescent display, a Plasma Display Panel (PDP), or a Cathode Ray Tube (CRT) display, to name a few of the more prominent examples. Although example system 1200 is shown with a particular configuration of components, other implementations are possible using any of a wide range of configurations. Further, those skilled in the art will recognize that system 1200 may include many additional components such as communications busses etc., not particularly germane to claimed subject matter, that have not been illustrated in FIG. 4 in the interests of not obscuring claimed subject matter.

### Example Method

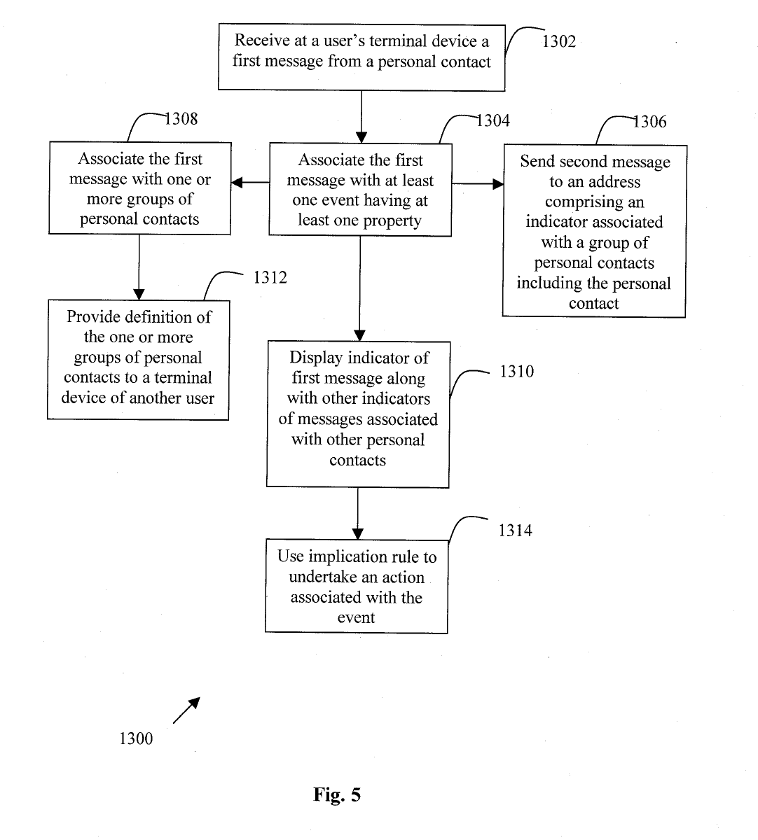

FIG. 5 is a flow diagram of an example method 1300 in accordance with some implementations of claimed subject matter. Method 1300 may implement and/or perform some or all of the various functions and/or schemes discussed above in connection with FIGS. 1-4 and details regarding the various acts of method 1300 have been provided above in reference to those figures and will not be repeated below in the discussion of FIG. 5. Any ordering of the acts shown in FIG. 5 does not limit claimed subject matter and does not imply that the acts must be undertaken in the order shown and/or that any particular act in FIG. 5 is necessarily dependent upon another act. In the description of FIG. 5 that follows references to the display of a message or an indicator of a message may refer to display of an associated message header along with a message or to display of an associated message header alone.

In act 1302, a first message from a personal contact may be received at a terminal device of a user, while in act 1304 that message may be associated with at least one event having at least one property. Further, in act 1306, a second message may be sent to an address comprising an indicator associated with a group of personal contacts that includes the personal contact that sent the message received in act 1302. In act 1308 the first message may be associated with one or more groups of personal contacts, while in act 1310, an indicator of the first message along with other indicators of messages associated with other personal contacts may be displayed. Further, in act 1312, a definition of the one or more groups of personal contacts may be provided to a terminal device of another user. In addition, in act 1314, an implication rule may be used to undertake an action associated with the event.

While particular implementations have just been described, claimed subject matter is not limited in scope to one or more particular implementations. For example, some implementations may be in hardware, such as employed to operate on a device or combination of devices, for example, whereas other implementations may be in software. Further, some implementations may be employed in firmware, or as any combination of hardware, software, and/or firmware, for example. Likewise, although claimed subject matter is not limited in scope in this respect, some implementations may comprise one or more articles, such as a storage medium or storage media. This storage media, such as, one or more CD-ROMs, computer disks, flash memory, or the like, for example, may have instructions stored thereon, that, when executed by a system, such as a computer system, computing platform, or other system, for example, may result in execution of an implementation of a method in accordance with claimed subject matter, such as one of the implementations previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations. Also, as used herein, the article “a” includes one or more items. Moreover, when terms or phrases such as “coupled” or “responsive” or “in response to” or “in communication with” are used herein or in the claims that follow, these terms should be interpreted broadly. For example, the phrase “coupled to” may refer to being communicatively, electrically and/or operatively coupled as appropriate for the context in which the phrase is used.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now, or in the future, occur to those skilled in the art. It is, therefore, to be understood that the appended claims are intended to cover all such modifications and/or changes as fall within the true spirit of claimed subject matter.

What is claimed:

1. A method, comprising:
receiving, at a terminal device, a first message from a personal contact; and
associating the first message with an event having a property;
wherein the property comprises at least one of information associated with the personal contact, and/or an action associated with the event.

2. The method of claim 1, wherein the event comprises at least one of a time interval and a scenario.

3. The method of claim 1, wherein information associated with the personal contact comprises at least one of a name of the personal contact, an acting role of the personal contact, and an indication of membership of the personal contact in a group of personal contacts.

4. The method of claim 3, wherein the group of personal contacts comprises a relationship ring.

5. The method of claim 3, wherein the personal contacts of the group of personal contacts share at least one of a familiarity, affection, respect, esteem, status, and/or acting role value with respect to the user.

6. The method of claim 3, further comprising:
sending a second message to an address comprising a indicator associated with the group of personal contacts.

7. The method of claim 1, wherein an action associated with the event comprises at least one of notifying the user that the message has been received, saving the message, deleting the message, classifying a calendar appointment and transferring the message.

8. The method of claim 1, wherein the terminal device comprises one of a computer, a telephone, and a personal digital assistant.

9. The method of claim 1, further comprising:
associating the first message with one or more groups of personal contacts.

10. The method of claim 9, further comprising:
displaying an indicator of the first message along with other indicators of messages associated with other personal contacts of the one or more groups of personal contacts.

11. The method of claim 9, further comprising:
providing a definition of the one or more groups of personal contacts to a second terminal device.

12. The method of claim 1, wherein the at least one property comprises at least one of a notification level associated with the terminal device and a status associated with the terminal device.

13. The method of claim 1, further comprising:
using an implication rule to undertake the action associated with the event, the implication rule comprising a function of the event and the first message.

14. An article comprising: a storage medium having stored therein instructions that, if executed, result in:
receiving a first message from a personal contact at a terminal device; and
associating the first message with an event having a property;
wherein the property comprises at least one of information associated with the personal contact, and an action associated with the event.

15. The article of claim 14, wherein the event comprises at least one of a time interval and a scenario.

16. The article of claim 14, wherein information associated with the personal contact comprises at least one of a name of the personal contact, an acting role of the personal contact, and an indication of membership of the personal contact in a group of personal contacts.

17. The article of claim 16, wherein the group of personal contacts comprises a relationship ring.

18. The article of claim 16, wherein the personal contacts of the group of personal contacts share a common familiarity, affection, respect, esteem, status, and/or acting role value with respect to the user.

19. The article of claim 16, wherein said instructions, if executed, further result in:
sending a second message to an address comprising a indicator associated with the group of personal contacts.

20. The article of claim 14, wherein an action associated with the event comprises at least one of notifying the user that the message has been received, saving the message, deleting the message, classifying a calendar appointment and transferring the message.

21. The method of claim 14, wherein the terminal device comprises one of a computer, a telephone, and a personal digital assistant.

22. The article of claim 14, wherein said instructions, if executed, further result in:
associating the first message with one or more groups of personal contacts.

23. The article of claim 22, wherein said instructions, if executed, further result in:
displaying an indicator of the first message along with other indicators of messages associated with other personal contacts of the one or more groups of personal contacts.

24. The article of claim 22, wherein said instructions, if executed, further result in:
providing a definition of the one or more groups of personal contacts to a second terminal device.

25. The article of claim 14, wherein the at least one property comprises at least one of a notification level associated with the terminal device and a status associated with the terminal device.

26. The article of claim 14, wherein said instructions, if executed, further result in:
using an implication rule to undertake the action associated with the event, the implication rule comprising a function of the scenario and the first message.

27. An apparatus, comprising:
a terminal device having logic adapted to provide a representation of a plurality of personal contacts;
wherein the representation comprises an indication of a first message received from a personal contact;
wherein the representation associates the indication of the first message with an event;
wherein the representation comprises an indication of a property associated with the event; and
wherein the property comprises at least one of information associated with the personal contact, and an action associated with the event.

28. The apparatus of claim 27, wherein the information associated with the personal contact comprises at least an indicator of membership of the personal contact in a group of personal contacts.

29. The apparatus of claim 28, wherein the group of personal contacts comprises a relationship ring.

30. The apparatus of claim 28, wherein the personal contacts of the group of personal contacts share at least a familiarity, affection, respect, esteem, status, and/or acting role value.

31. The apparatus of claim 27, wherein an action associated with the event comprises at least one of notifying the terminal device that the message has been received, saving the message, deleting the message, classifying a calendar appointment and transferring the message.

32. The apparatus of claim 27, wherein the terminal device comprises one of a computer, a telephone, and a personal digital assistant.

33. The apparatus of claim 27, the terminal device having logic further adapted to:
display an indicator of the first message along with other indicators of messages associated with other personal contacts of the one or more groups of personal contacts.

34. A system, comprising:
a processor;
memory coupled to the processor; and
a display coupled to the processor;
wherein the processor is adapted to provide a representation of a plurality of personal contacts;
wherein the representation comprises an indication of a first message received from a personal contact;
wherein the representation associates the indication of the first message with an indication of an event;
wherein the representation comprises an indication of a property associated with the event; and
wherein the property comprises at least one of information associated with the personal contact, and an action associated with the event.

35. The system of claim 34, wherein the memory is adapted to store at least a portion of the representation.

36. The system of claim 34, wherein the display is adapted to provide a graphical user interface including at least portion of the representation.

37. The system of claim 34, wherein the information associated with the personal contact comprises at least an indicator of membership of the personal contact in a group of personal contacts.

38. The system of claim 37, wherein the group of personal contacts comprises a relationship ring.

39. The system of claim 37, wherein the personal contacts of the group of personal contacts share a common familiarity, affection, respect, esteem, status, and/or acting role value.
